(19) United States
(12) Patent Application Publication
(10) Pub. No.: US 2006/0061020 A1
(43) Pub. Date: Mar. 23, 2006

(54) Drying ceramic articles during manufacture

(76) Inventors: Andrew Mark Wynn, Worcestershire (GB); Nashim Imam, Worcestershire (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/518,191

(22) PCT Filed: Jun. 18, 2002
(86) PCT No.: PCT/GB02/02815

§ 371 Date: Dec. 16, 2004

(51) Int. Cl. C04B 35/64

(52) U.S. Cl. 264/669

(57) ABSTRACT

A method of forming a ceramic material or body comprises the steps of:—i) providing a water-containing mixture of raw materials ii) forming said mixture into a shape iii) removing water from said shape iv) firing said shape at a temperature sufficient to effect sintering and/or reaction of the raw materials and thereby form a ceramic material or body in which the raw materials include a hygroscopic polymeric material capable of retaining water in the mixture over, a range of temperatures above the boiling point of water. The hygroscopic polymeric material may be a so-called superabsorber, and the raw materials may comprise silicon carbide, graphite, sugar, and starch.

This invention relates to a method of drying ceramic articles during manufacture and is particularly, although not exclusively, applicable to the manufacture of carbon and carbon/silicon carbide composite materials. The invention also extends to binder systems used in such materials.

The term “ceramic” should be interpreted in this context in its broadest definition of meaning any non-metal polycrystalline material bonded through sintering or reaction. The invention encompasses carbides, nitrides, oxides, graphite, carbon, phosphides, borides and indeed any ceramic formed using a process in which removal of water is a step in manufacture.

Ceramics is one of the oldest technologies and extends from traditional pottery to tailored composite materials. The majority of manufacturing techniques for ceramic articles or materials commonly include the steps of:—
a) Providing a water-containing mixture of raw materials of a consistency appropriate for a desired forming technique.
b) Forming the said mixture into a shape.
c) Removing water from said shape.
d) Firing said shape at a temperature sufficient to effect a sintering and/or reaction of the materials of the mixture and thereby form a ceramic article or material.

As an example, in slip casting of materials:—
a) A runny dispersion (“slip”) of raw materials is poured into a porous mould.
b) Water is drawn out of the slip through the walls of the mould to produce a “green” formed body.
c) The green formed body is dried to remove water.
e) The green formed body is then fired at an appropriate temperature to cause reaction and/or sintering the raw materials to produce a fired ceramic body.

Other ceramic processing techniques to form green bodies include (among others):—pressing; jiggering; extrusion; and rolling. The present invention is not restricted to any one method of forming the green bodies.

A problem that arises in forming ceramics by such techniques is the removal of water. This is commonly done by heating the green body so that the water evaporates. In evaporation the water escapes through porosity in the green body. If the evaporation takes place too quickly, water vapour cannot readily escape through the porosity in the green body and can cause damage to the green body through cracking and/or bloating of the green body. Accordingly a large part of the processing time in forming ceramics can be in the drying step.

Known methods of reducing the time of drying and/or reducing the damaging effects of drying include the incorporation of straw-like materials into the green body to provide easy passageways for escaping vapour. For example, traditionally, horse dung or the like has been incorporated into bricks to give the porosity to allow ready water removal, and to give some green strength to the material of the bricks. In recent years the horse dung of antiquity has been replaced by the polypropylene fibre of modernity, but the technique still has the drawbacks that:
i) Uniformly dispersing the straw-like materials can be a problem so leading to non-uniform loss of water with the potential for distortion of the green body.
ii) After firing the ceramic, the straw-like material leaves channels of connected porosity, which can be a problem in some applications.

These methods of drying do not affect the basic fact that water boils at 100° C. (at atmospheric pressure) and that as a wet article passes through the boiling point all of the water will be released. The applicants have realised that by the use of polymeric hygroscopic materials (superabsorbers) it is possible to slow the release of water so that it occurs over a range of temperatures above the normal boiling point of water.

Accordingly, the present invention provides a method of forming a ceramic material or body comprising the steps of:—
i) providing a water-containing mixture of raw materials
ii) forming said mixture into a shape
iii) removing water from said shape
iv) firing said shape at a temperature sufficient to effect sintering and/or reaction of the raw materials and thereby form a ceramic material or body
   in which the raw materials include a hygroscopic polymeric material capable of retaining water in the mixture over a range of temperatures above the boiling point of water.

The invention further comprises the use as a component of a raw material mixture used in the production of a ceramic of a hygroscopic polymeric material to retain water in the mixture over a range of temperatures above the boiling point of water.

In a further aspect the invention comprises a raw material mixture, used in the production of a ceramic, comprising a hygroscopic polymeric material capable of retaining water in the mixture at a range of temperatures above the boiling point of water.

In a still further aspect, the invention extends to a method of forming a ceramic article by the steps of forming, a green body and firing the green body at a temperature sufficient to carbonise a carbonisable binder in the green body, in which the carbonisable binder comprises a sugar syrup and a carbonaceous additive increasing the carbon yield of the binder upon firing.

Further features of the invention are made apparent in the claims and the following description which, describes an embodiment of the invention in a method of using a sugar as the carbon source as a binder in silicon carbide/graphite crucibles. The invention is not limited to such products, but the technical features discussed may be of relevance to other ceramic bodies.

The invention is exemplified in the following with reference to the drawings in which:—

FIG. 1 is a plot showing the carbon yield versus the “cured” yield of a sugar-based binder

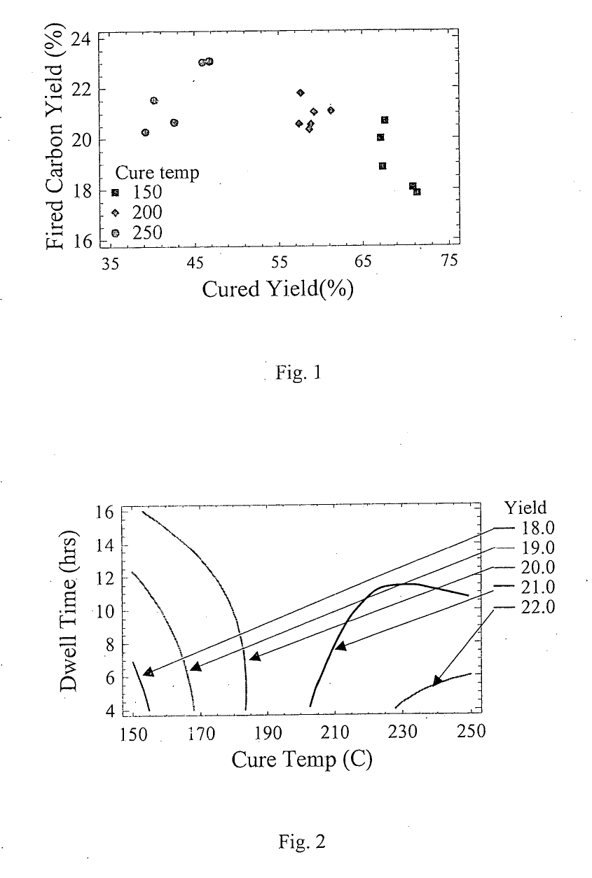

FIG. 2 is a plot showing fired carbon yield versus “curing” conditions for a sugar-based binder

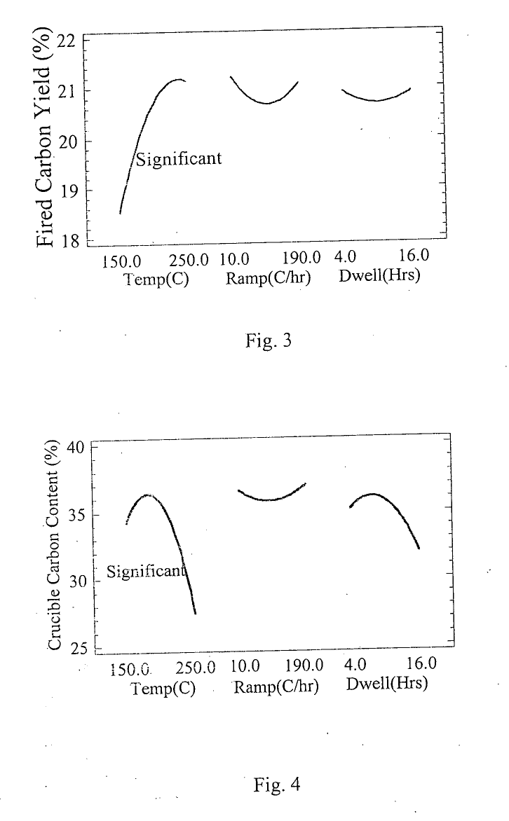

FIG. 3 is a plot showing the influence of the “curing” conditions on the residual carbon yield for a sugar-based binder

FIG. 4 is a plot showing carbon content of a sugar-based binder in crucible samples

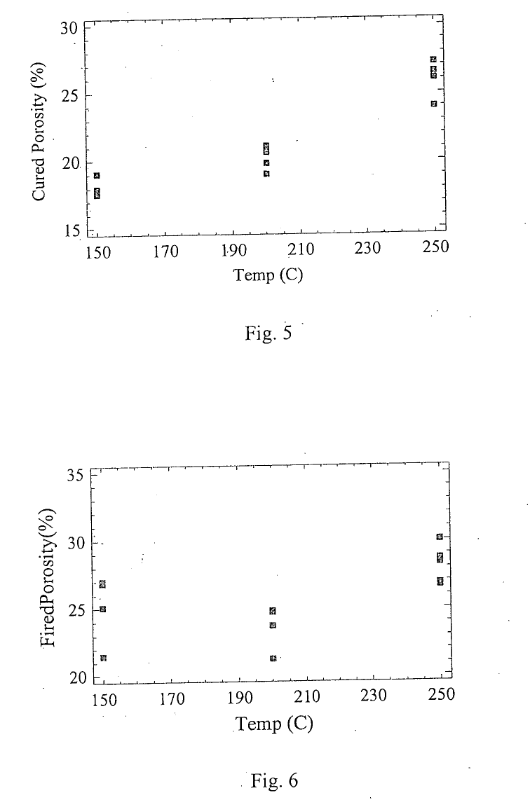

FIG. 5 is a plot of the “cured” porosity at different “curing” temperatures for a sugar-based binder

FIG. 6 is a plot of the fired porosity at different “curing” temperatures for a sugar-based binder

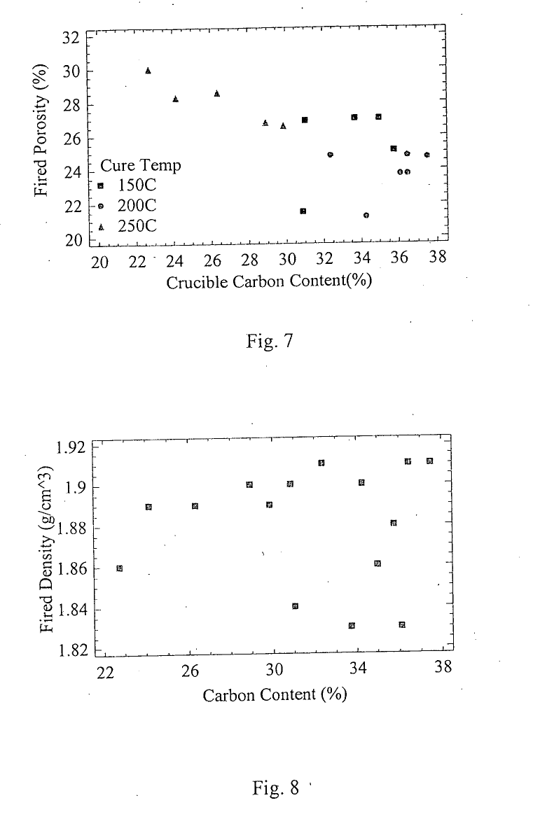

FIG. 7 is a plot of fired porosity against the carbon content of the crucible for a sugar-based binder

FIG. 8 is a plot of crucible fired density against carbon content for a sugar-based binder

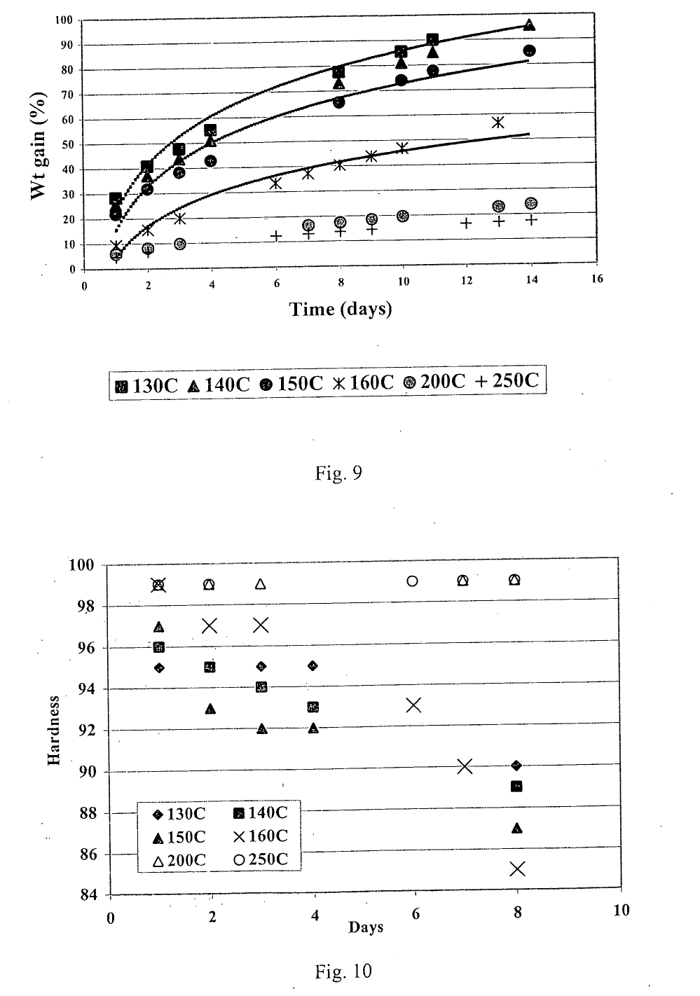

FIG. 9 is a plot of weight gain against number of days in the humidity chamber for crucible samples using a sugar-based binder

FIG. 10 is a plot of hardness against “curing” temperature for crucible samples using a sugar-based binder

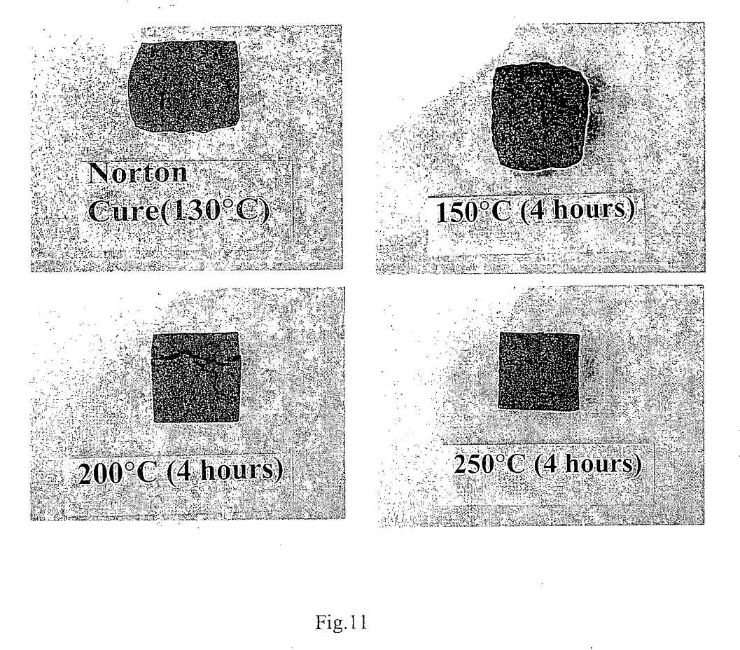

FIG. 11 is a photograph showing the effects of humidity on crucible samples using a sugar-based binder subjected to eight days in a humidity chamber

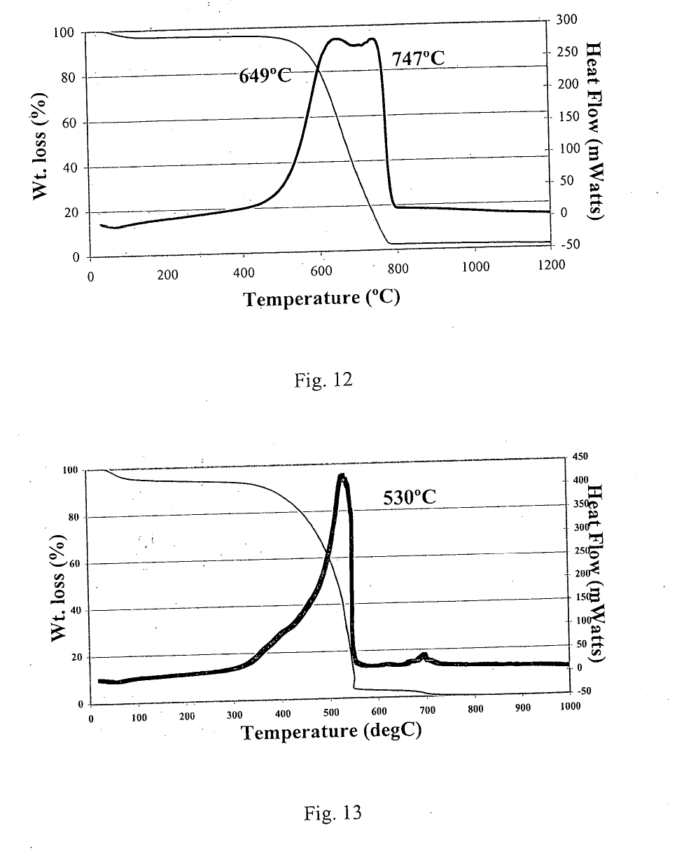

FIG. 12 is a thermogravimetric plot (TGA) of the carbonising of a phenolic resin binder used for conventional crucible manufacture

FIG. 13 is a thermogravimetric plot (TGA) of the carbonising of a sugar-based binder used for crucible manufacture

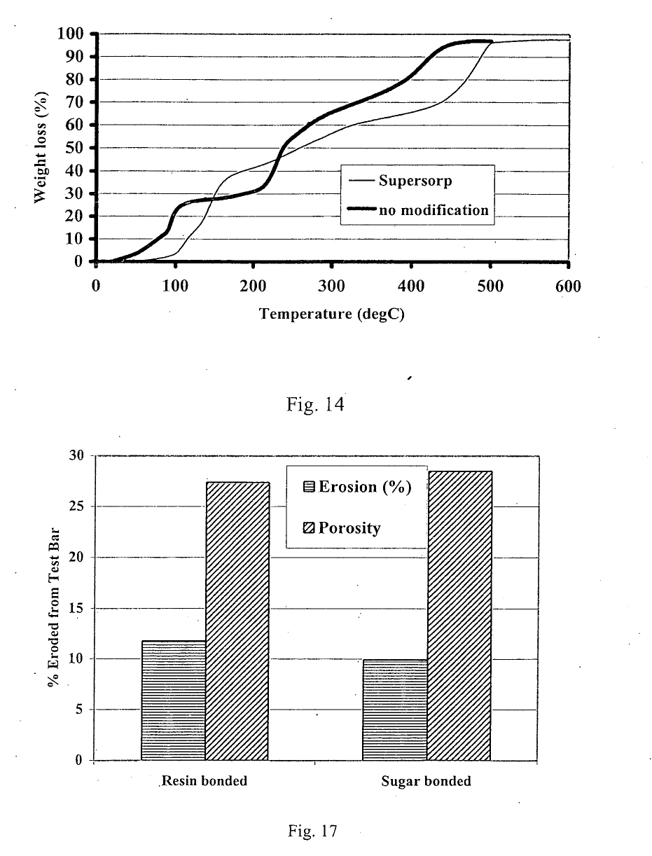

FIG. 14 is a thermogravimetric plot (TGA) of the carbonising of a crucible mix with and without the addition of a superabsorber

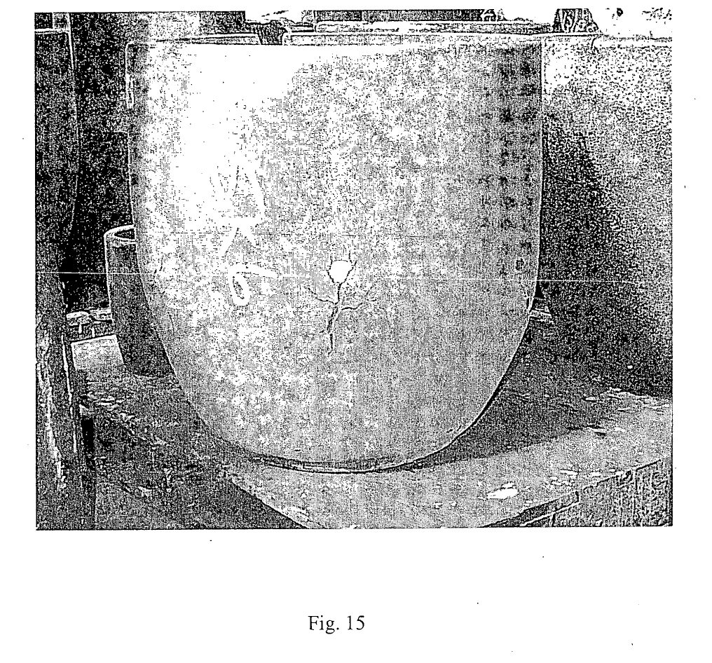

FIG. 15 is a photograph of a crucible formed using a sugar-based binder without the addition of a superabsorber

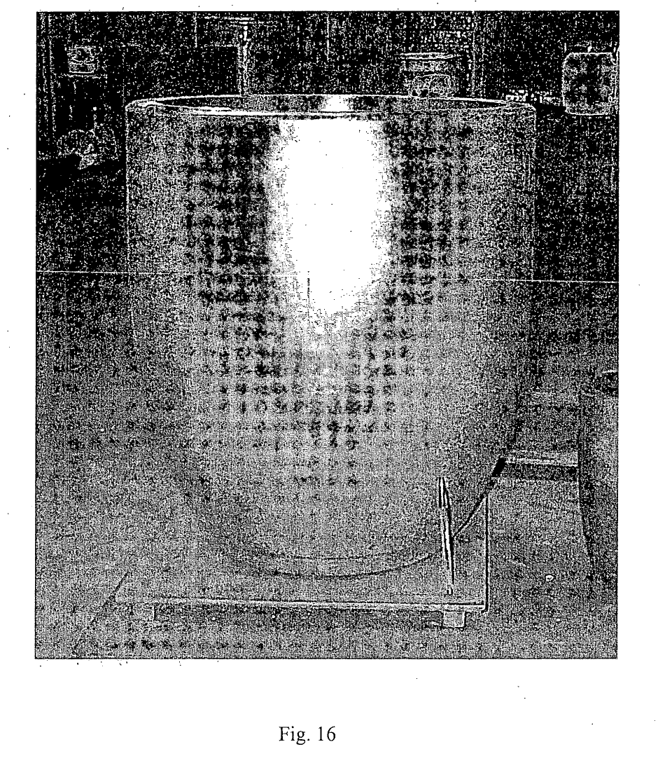

FIG. 16 is a photograph of a crucible formed using a sugar-based binder with the addition of a superabsorber

FIG. 17 is a plot showing erosion of a crucible material formed using a sugar-based binder in comparison with a crucible material formed using a phenolic resin binder

In use, crucibles manufactured from graphite and silicon carbide can be expected to hold molten substrates at temperatures as high as 1400° C., therefore a number of physical properties are required of them. These properties include flexural strength, thermal conductivity, oxidation resistance and erosion resistance.

Silicon carbide based crucibles are traditionally formed from a mixture of silicon carbide powder and graphite flakes bound together by the carbonised residue of a binder compound, for example a resin, pitch or tar. The manufacturing steps typically comprise several of the following steps:—
pressing the mixture of silicon carbide, graphite, and binder to form a green body
“fettling” the green body (e.g. machining the body to a final green shape, adding spouts or handling lugs)
curing the green body to remove volatiles from the binder and/or set the binder
firing the green body at a temperature and for a time sufficient to carbonise the binder
applying a glaze to the finished crucible to protect the body of the crucible against oxidation

Typically, the pressing step is by either isostatic pressing or by roller pressing (in which a roller presses the mixture against the inside of a mould).

Before firing, the binder holds together the “green” crucible to provide adequate mechanical strength for the handling and fettling. Once cured and fired, the binder carbonises to leave a residual carbon skeleton that contributes to the structure of the crucible.

The use of carbon precursors based on resin, pitch and tar in the manufacture of crucibles is coming under increasing pressure due to environmental, health and safety concerns. In the past, legislation associated with these matters has been a factor in the replacement of pitch and tar with phenol based resins such as novalac resins. There are now increasing health concerns with the use of phenol based binders, and legislation may eventually make their use uneconomical.

In order for a binder to replace the existing pitch, tar or phenol formaldehyde resin used in the crucible industry, it must fulfil a series of requirements. The binder should have:—
a) a significant carbon yield after firing so that the fired crucible has both good thermal conductivity and thermal shock resistance
b) strength on drying “curing” so that it can be handled and/or shaped (“fettled”) prior to firing
c) good mouldability during the forming stage (e.g. sufficient stickiness if formed by a roller forming process)
d) chemical properties compatible with the application the crucible is to be used for.

In order to meet these requirements, the applicants investigated the use of a sugar binding formulation in an attempt to provide a crucible mix which:—
once cured and fired, produces crucibles with comparable characteristics to those produced using phenolic resin binder systems
can withstand the curing and firing process without the problems of blistering and bloating otherwise encountered using sugar based systems
has a comparable curing and firing time to crucibles produced using phenolic resin binder systems.
   The Binder

The first issue addressed was to identify sugar based systems that would produce an appropriate level of carbon when carbonised.

Molasses was obtained from the company British Sugar and was primarily a beet molasses containing 50% sugars in the fresh weight composition. The predominant sugar was sucrose, C₁₂H₂₂O₁₁ which has a theoretical carbon content of 42%. Due to the high variable ash content of molasses, pure sugar syrups were also considered.

Two types of sugar syrup were used, both derived from wheat. These sugars were chosen as they are pure sugar syrups and for their theoretical carbon content and loss of ignition (LOI). The sugars chosen were Adeptose B51™ and Abrasol™ obtainable from Roquette UK Ltd. (formerly ABR Foods Limited) of Sallow Road, Corby, Northamptonshire, England.

Adeptose B51™ is a pure sugar syrup which has a loss of ignition (LOI) of 100%. Abrasol™ is also a pure sugar syrup which has a LOI (Loss on Ignition) of 99.8%.

Table 1 shows the carbon content determined by TGA (Thermo-Gravimetric Analysis) of the different sugars and phenolic resin. A comparison is also made in Table 1 with a theoretical carbon content derived from the relative molecular mass of the sugars and resin. The carbon content from the TGA is calculated from the weight change during heating. Since it was difficult to differentiate between the volatiles and those related to the oxidation of carbon, the TGA was performed from room temperature at a ramp rate of 10° C./min under an argon atmosphere to 800° C. to remove all volatiles, and then repeated under air to oxidise the remaining carbon. The carbon content determined from the TGA would be a realistic value as seen in the crucible.

TABLE 1

| | Solids | | | |
|---|---|---|---|---|
| | content of as | | | |
| | supplied | Theoretical | Carbon | |
| | material | Carbon | content by | |
| Type | (%) | Content (%) | TGA (%). | LOI % |
| Adeptose | 82.9 | 33.16 | 15.73 | 100 |
| B51 ™ | | | | |
| Abrasol ™ | 80.9 | 32.36 | 18.40 | 99.8 |
| Molasses | 50 | 21.0 | 6.5 | 88.8 |
| Phenolic | 70 | 68 | 29 | 100 |
| resin (Borden | | | | |
| Chemical | | | | |
| UK Ltd.) | | | | |

A majority of the carbon is lost through volatilisation at around 200° C. Literature proposes that the main volatiles that can be present are water vapour, carbon monoxide, carbon dioxide, acetic acid and methanol. The ratios of the volatiles and whether all of these are present (e.g. acetic acid) depend on the conditions used.

Although Abrasol™ possessed a greater carbon content than Adeptose B51™ or molasses, which may be attributed to a small amount of protein which has a higher carbon content than glucose (C₆H₁₂O₆), there is still a small trace of ash present. Due to this, the pure sugar syrup, Adeptose B51™ was favoured in trial mixes. However, the invention is not restricted to the use of Adeptose, and Abrasol™ or molasses may be of use. Preferably however the solids content of the sugar syrup is more than 70% so as to reduce the amount of water that has to be disposed of. More preferably the carbon content (as assessed by TGA) of the sugar syrup used is above 10%, more preferably above 15% by weight. Also, desirably the ash content of the sugar syrup is 5% by weight. More desirably, the ash content is less than 1%.

The carbon content of Adeptose B51™ (and indeed Abrasol™ and molasses) is much less than the resin. To increase the carbon content of the sugar syrup other carbonaceous materials were added to the binder to boost its carbon yield and to contribute to the carbon bonding system. One source of cheap raw material added to the syrup is a starch, dextrine, which is a long polysaccharide chain as opposed to a singular monosaccharide such as glucose. The amount of dextrine that can be added to the binder is influenced by the wettability of the sugar syrup with the dry raw powders of a typical crucible mix. Typically, around 12% phenol formaldehyde resin is added to a crucible mix. Trials have shown that typically 15% of the sugar syrup is necessary to wet the dry powders, to which, typically 2% dextrine powder can be added to boost the carbon yield.

As is discussed more fully below, the binder may benefit from cross linking and/or catalysing the carbonisation reaction.

Drying and Curing Regime

Since moisture is inherent in the sugar syrup, the carbonisation yield is influenced by the moisture content of the binder after the drying/“curing” stage. Thus the drying/“curing” stage is one of the critical steps in the production of an adequate carbon yield and bonding system in the crucible.

The prime reason for the drying/“curing” stage is the removal of the water from the syrup and to form a rigid sugar bond to strengthen the green body for handling, fettling and glazing. The drying/“curing” stage is the most important step to achieve an adequate carbon bond, since residual moisture in the bond or bound water may assist with the volatilisation of the sugar binder and/or oxidation of the carbon.

The drying/“curing” stage is influenced by both the oven temperature and dwell time. The very hygroscopic properties of both glucose and fructose which make up Adeptose B51™, would mean that if the “curing” stage is not carried out sufficiently, then the bond would reabsorb water from the atmosphere especially in humid conditions during the Summer months. This may weaken the green strength of the body and assist with the oxidation of the carbon bond during the firing stage. Hence a lower carbon yield may result. (By analogy, literature on wood carbonisation [Emrich, W. and Booth, H. “Industrial Charcoal Making.” Forestry Paper 63, Food and Agriculture Organization of the United Nations, Rome, Italy, 1985] reveals that wood will not carbonise until it is practically bone dry and there can be a significant loss of charcoal yield if there is an excessive moisture content of the wood).

Sugars eventually turn brown during heating. There are three basic non-enzymic browning reactions [Edwards, W. P. “The Science of Sugar Confectionery.” Royal Society of Chemistry (RS.C) Publication 2000 and Shallenberger, R. S. and Birch, G. G. “Sugar Chemistry.” Avi. Publishing Co. Inc. Westpoint. Conn., 1975].

These are:
Pyrolysis
Caramelisation
Maillard Reaction

Pyrolysis is simply scorching, and involves the total loss of water from the sugar molecule and the breaking of carbon-carbon linkages, i.e. the destruction of the sugar molecule.

Caramelisation is a heat induced transformation of reducing sugars. The classic caramelisation reaction is the phenomenon exhibited by sucrose when subjected to heat, although commercial caramels are produced from sugar syrups. When sucrose is melted at 160° C. and kept at that temperature, glucose plus fructose anhydride (levulosan, C₆H₁₀O₆) is generated.

At 200° C. Shumaker and Buchanan [Shumaker, J. B and Buchanan, J. H. “A study of Caramel Color.” Iowa State Journal Sci. Vol. 6, pp. 367-379, 1932] observed 3 distinct endothermic events during sucrose caramelisation. After the sucrose had melted, foaming began and then stopped after 35 minutes. The weight loss was 4.5% which corresponds to the loss of one molecule of water per molecule of sucrose and is thus analogous to the formation of anhydrides such as isosacchrosan. A second stage of foaming soon began which lasted for 55 minutes. The weight loss from the system was 9%, which agrees well with the average molecular formula for the pigment caramelan, or
2C₁₁H₂₂O₁₁-5H₂O=C₂₄H₃₆O₁₈
which requires a weight loss of 10.5%. A third stage of foaming which began after 55 minutes was characterized by caramelen formation. The average molecular weight of the pigment corresponds to the loss of 8 molecules of water from 3 molecules of sucrose,
3C₁₂H₂₂O₁₁-8H₂O=C₃₆H₅₀O₂₅
and a weight loss of 14%. Continued heating leads to the formation of humin, a dark infusible mass of high molecular-weight. Janacek [Janacek, O. “Behaviour of Sucrose on heating and composition of Caramel substances so obtained.” Centr. Zukerind, Vol. 47 pp. 647-648. 1939] and others place the average molecular formula at about C₁₂₅H₁₈₈O₈₀. Continuation of the reaction yields higher molecular weight products and increasing proportions of carbon by progressive dehydration.

Maillard reactions are responsible for the browning of sugars in the presence of amino acids. They are one of the key routes to flavour compounds in foods. Sources of amino acids are derived from proteins such as milk, fats, etc and are responsible for the production of toffee. The absence of any amino acids in the crucible mix would mean that this reaction may not be responsible for the browning of the sugar.

The main reaction occurring through the browning of the sugar in the crucible mixes is pyrolysis. The complexity of the possible carbonisation pathways of sugar based systems indicates however that the carbon yield may be highly dependent upon the sugars used and the drying/“curing” regime. For example, additions of amino acids could result in Maillard reactions that may provide higher carbon yields (Compare Abrasol™ with Adeptose B51™ in Table 1).

The applicants consider that:—
cross-linking or caramelisation of the binder system alone in a controlled way leads to improved carbon yield from the binder on rapid firing
cross linking and caramelisation in a controlled way leads to improved carbon yields from a crucible mix on firing.

The influence of various “curing” temperatures, times and ramp rates of the total binder system on the final carbon yield was investigated. The binder system used in these trials was a combination of Adeptose B51™ syrup with dextrine powder. A small quantity of a polyacrylate material Supersorp® was added to the binder system to prevent bloating of the crucibles (as discussed below). Table 2 shows the binder mixture used in the carbonisation trials.

TABLE 2

| Component | Content (wt %) |
|---|---|
| Adeptose B51 ™ Syrup | 86 |
| Dextrine | 11.5 |
| Supersorp ® | 2.5 |

Carbonisation of the “cured” binder involved heating the binder to 900° C. under an inert atmosphere such as argon to remove all volatiles and determining the final carbon yield by weight, assuming conversion to carbon. The principle is similar to the technique used to determine the carbon content using the TGA. However a much larger sample size was used instead of a few milligrams in order to improve on the accuracy and speed of results.

Samples of the pre-mixed binder were placed in small alumina boats which were placed in an alumina tube furnace. The alumina tube was sufficiently long (1370 mm) so that a cold zone could be maintained at either end so as to prevent the binder from further “curing” whilst in the tube furnace. The samples were placed in the cold end of the tube, sealed and the tube continuously flushed with argon. After 2 hours in the cold zone, the samples were pushed (using a stainless steel rod) into the hot zone at 900° C. and soaked for a further 2 hours.

The samples were then pushed through to the other end of the tube to cool down. Once cool the samples were removed from the tube furnace and weighed to determine their weight change. Assuming that all the volatiles had been removed at 900° C. the remaining mass is carbon. This was confirmed by both SEM and XRD analysis.

A combination of twenty one experiments were carried out to see the effects of “curing” temperature [over a range 150° C. to 250° C.], ramp rate [over a range 10° C./hour to 190° C./hour] and dwell time [over a range 4 hours-16 hours].

Similar tests were performed with green crucible pieces (2 cm×2 cm×2 cm) cut from the midwall of a green crucible and “cured”, prior to firing in the tube furnace to 900° C. In both the binder trials and the green crucible trials, sample weights were noted before and after firing.

Both the density and porosity of the crucible pieces were also measured. Due to the solubility of the “cured” Adeptose B51™ binder in water, density and porosity values of the “cured” crucible pieces were determined by immersion in white spirit.

Other variables that may influence the carbon yield were investigated and a comparison was made with a standard resin sample. The other variables were:
1. The effect of humidity
2. The effect of not “curing” the sample prior to firing
3. The effect of dehydrating the binder to caramelisation using concentrated sulphuric acid.

To test the effect of humidity an atmosphere of about 80% relative humidity was generated in a sealed chamber using concentrated salt solution. The degree of hygroscopicity of the mix was measured by the weight gain through water absorption and by the resultant hardness using a Hampden Hardness T ester (Durometer Model B101).

FIG. 1 shows for the binder samples a comparison of the fired carbon yield versus the “cured” yield. The figure clearly shows that the lower the “cured” yield as a result of a higher “cure” temperature, the greater the fired carbon yield. A “curing” temperature of 250° C. offered the highest carbon yield of about 23%.

A similar conclusion can be made from the contour plot shown in FIG. 2 for fired carbon yield versus “curing” conditions (dwell time and temperature) at a constant ramp rate of 100° C./hour. The plot indicates that an ideal condition would be a high “curing” temperature (around 230° C.-250° C.) and a low dwell time (around 4-6 hours).

A summary of the influence of the “curing” conditions on the residual carbon yield, shown in FIG. 3, indicates that temperature of “curing” has more of a significant effect in comparison to both the ramp rate and dwell time. Of course the optimum curing and firing conditions will vary from binding system to binding system and those indicated above apply only to the particular binding system disclosed. It is a matter of routine experiment to finds optimum conditions for a particular binding system.

It should be noted that the conditions that achieve the best carbon yield in such experiments may not match the conditions that achieve the best yield in a fired crucible. For example, the carbon content of the binder in the crucible pieces from the crucible midwall, shown in FIG. 4, also reveals that temperature has the biggest influence, but that the greatest carbon yield occurs at temperatures less than 250° C. Desirably, the carbon yield is greater than 20%.

The carbon yield in the crucible pieces was derived from the weight loss on firing assuming all the weight loss was attributed to the 15% binder in the mix. This has an opposite effect to the carbon yield from the binder alone, and may be attributed to other weight losses/gains in the crucible mix besides the binder. According to FIG. 4 the dwell time also shows an effect on the carbon content. A low dwell time seems to be more preferable than a long dwell time.

In terms of density and porosity of the crucible, FIG. 5 shows a plot of the “cured” porosity at different “curing” temperatures. As might be expected the “cured” porosity increases with increasing “curing” temperature.

A plot of the fired porosity at different “curing” temperatures shown in FIG. 6, indicates that the fired porosity reaches a minimum at a “curing” temperature of 200° C.

This is further explained by the plot of fired porosity against the carbon content of the crucible (see FIG. 7). A cluster of points of generally higher carbon content associated with the 200° C. “curing” temperature, inevitably results in a lower porosity. FIG. 8 plots the crucible fired density against carbon content and indicates a trend of increased density with increasing carbon content. FIG. 8 shows two trends, each with different gradients. This may be attributed to position of the sample from the midwall of the crucible, since the density varies from top to bottom of the crucible due to the making characteristics. The top of the crucible sees a greater green density of about 2.1 g/cm³ whereas the base sees a lower green density of 1.75 g/cm³.

The “curing” temperature also has a significant effect on the degree of hygroscopicity of the mix. Since the degree of hygroscopicity of the sugar binder is dependent upon the amount of water still: present in the binder after “curing”, equation (1) was used to demonstrate the effect of humidity.

$$Weight Gain ( \% ) = \frac{Wt . Gain in Humidity chamber}{Wt . Loss after curing} \times 100 \qquad ( 1 )$$

FIG. 9 shows a plot of weight gain determined from equation (1) against the number of days in the humidity chamber. It is clearly apparent in FIG. 9 that the higher the “curing” temperature the less hygroscopic the material. Samples that are “cured” at low temperatures of about 150° C. eventually re-absorb water that was lost through drying/“curing”, which is normally 20%. Water absorption has detrimental effects to the strength of the “cured” crucibles. FIG. 10 shows how the hardness deteriorates with reduced “curing” temperature. A “curing” temperature above 200° C. seems to offer the best resistance to humidity and this is probably related to the degree of pyrolysis of the sugar molecule.

Table 3 shows the effects of humidity on the carbon yield of the binder. Samples of the binder which have not been “cured” and subjected to instantaneous firing in the tube furnace suffer from a much lower carbon content than when the samples are “cured” prior to firing. Humidity has a slightly detrimental effect on the carbon yield. The effect seems to be more pronounced for the lower temperature “curing”. Also the dehydration of the sugar binder with sulphuric acid into a caramelised state without the need for heating, has a positive influence on the carbon yield. This indicates that the use of catalysts or additives to assist with the caramelisation stage and/or cross-linking of the sugars may assist in raising the residual carbon yield.

TABLE 3

| Curing Conditions | % Carbon content |
|---|---|
| No Cure | 13.2 |
| 100° C./hr - 90° C. then 15° C./hr - 130° C. | 24.8 |
| 100° C./hr - 90° C., 15° C./hr - 130° C. | 17.8 |
| (humid) | |
| 100° C./hr - 150° C. - 4 hrs | 18.7 |
| 100° C./hr - 150° C. - 4 hrs (humid) | 17.8 |
| 100° C./hr - 200° C. - 4 hrs | 21.0 |
| 100° C./hr - 200° C. - 4 hrs (humid) | 19.0 |
| 100° C./hr - 250° C. - 4 hrs | 23.0 |
| 100° C./hr - 250° C. - 4 hrs (humid) | 22.6 |
| Sulphuric Acid | 26 |

The effects on Humidity of the Carbon yields. Temperatures shown in Bold are the final Curing Temperatures.

The effects of humidity can also be seen in the crucible pieces. FIG. 11 shows the effects of humidity on crucible samples subjected to eight days in a humidity chamber and then fired in the tube furnace to 900° C. It can clearly be seen in the figure that crucible pieces which have been “cured” at temperature at 200° C. or below suffered from bloating problems when fired. However, the sample which was “cured” to 250° C. did not suffer from bloating problems when rapidly fired in the tube furnace.

A typical curing/drying cycle for roller formed crucibles is;
100° C./hr to 90° C.
15° C./hr to 130° C.
hold 7.5 hrs
100° C./hr to 200° C.
hold 7.5 hrs
   giving a total time of less than 20 hours—comparable with the 15 hours to be expected for phenolic binders but considerably less than the days to be expected otherwise for a water based system.

TGAs of the carburised resin and sugar shown in FIGS. 12 and 13, show that the carbon derived from sugar oxidizes at a lower temperature than the carbon derived from the resin (530° C. as opposed to 649° C.). Thus, the crucible bond using a sugar binder is likely to be more susceptible to oxidation. The external glaze of the crucible should therefore soften at temperatures around 500° C. to offer protection against oxidation of the binder during firing and in commercial use.

Sample crucibles made to the recipe of FIG. 15 in Table 5 below were dried/“cured” to 150° C., glazed and then finally fired in a production kiln to 1325° C. The standard glaze used on phenolic resin based crucibles posed very few problems with the sugar based crucibles. The finish of the glaze after firing was both adequate and similar to a fired resin based crucible. Properties of the fired crucible were measured and compared to a resin bonded crucible having identical components but comprising 12% phenolic resin as a binder in place of the Adeptose B51™, dextrine and polyacrylate binder system. The comparative properties are shown in Table 4.

TABLE 4

| Properties | Sugar Bonded | Resin Bonded |
|---|---|---|
| Flexural Strength (MPa) | 8.3 +/− 0.4 | 10.1 |
| Thermal Conductivity | 19.4 | 18.3 |
| (Wm⁻¹K⁻¹) | | |
| Time Taken to melt a | 3 hours 20 minutes | 3 hours 10 minutes |
| Fixed Quantity of | | |
| Aluminium | | |
| Rst (m^{1/2} ° C.) | 39.1 | 25.0 |

According to Table 4, the properties of the sugar bonded crucible are very similar to a traditional resin bonded crucible. The high Rst value, which is a thermal shock parameter, is partly related to the higher porosity and lower density of the fired sugar bonded crucible and may also possibly due to fine porosity amorphous carbon formed from sugar. Since these crucibles were “cured” to 150° C. further improvements in porosity may be possible by increasing the “curing” temperature to 200° C.

The higher porosity inherently found in the sugar bonded crucibles could have meant that the crucible would suffer from erosion problems. However, according to FIG. 17, showing a comparison of the erosion properties of sugar versus resin bonded crucibles, it is clearly apparent that there is very little difference between the degree of erosion with molten copper at 1200° C. of both sugar and resin bonded crucibles for samples taken from the crucible midwall.

To achieve appropriate viscosity for mixing the sugar-based binder with the silicon carbine/graphite powders, it was found preferable to heat the sugar-based binder prior to mixing so as to lower its viscosity. A temperature above 50° C. was preferred.

Drying Additives

Extremely long drying times in the excess of 2 days are typically required to dry articles bonded by sugars, e.g. molasses, in order to be handled effectively for fettling. This still does not guarantee that the article is free from defects. The total “curing” time with phenolic resins is about 15 hours. To be an effective replacement for phenolic resins, a means had to be found for reducing drying times.

It was suspected by the applicants that the main reason for bloating of sugars is the rapid escape of water vapour under pressure. Sugar syrup naturally forms a skin on its surface. In order for the water vapour to escape as the pressure builds up it needs to break this skin. To reduce the drying time of sugar bonded crucibles without causing blistering and bloating a means of absorbing the water vapour was needed that released it at a much higher temperature once gaseous passageways have formed in the skin.

The inventors decided on the use of superabsorbers as an additive. Superabsorbers are very powerful hygroscopic polymeric materials, commonly used in babies nappies and other absorbent sanitary towels (see for example WO9415651, WO9701003, and U.S. 2001047060). Superabsorbers are conventionally used in such applications as granulated materials or as woven or non-woven textiles.

When added as a fine powder to sugar syrup, typically at less than the 1% level, the applicants have found superabsorbers absorb water from the syrup during the drying stage and release it at a much higher temperature. The material used by the applicants in tests was a sodium/potassium polyacrylate, which is a non-toxic white powder. The material was bought in bulk under the trade name Supersorp® from Huvec Klimaatbeheersing of Postbus 5426, 3299 ZG MAASDAM, Belgium.

Typically, superabsorbers are provided as a granulate. The powder used by the applicants was a fine powder with 75% between 75-150 μm. Preferred materials have 75% by weight or more of a size less than 150 μm.

Superabsorbers such as sodium polyacrylate (formula shown below) are polymeric materials having a large number of hydrophilic groups that can bond with water. The present invention extends to any hygroscopic polymeric material, such as a superabsorber, that can absorb large quantities of water and release the water over a range of temperatures. Typically a superabsorber can absorb more than 5 grams of water per gram of material and absorbencies of >10 g/g, >15 g/g and >20 g/g are not unusual (see U.S. Pat. No. 5,610,220) and indeed absorbencies of >100 g/g are known for distilled water of 400-500 g/g and lower in salt solutions (e.g. 30-70 g/g in 0.9% NaCl solution). Preferred materials for the present invention have absorbencies for distilled water above 100 g/g, more preferably above 200 g/g.

### Formula of Sodium Polyacrylate

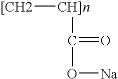

FIG. 14 shows TGA plots for a sugar syrup binder without sodium polyacrylate and for a mixture of pure sugar syrup and sodium polyacrylate crystals in the syrup. The presence of the polyacrylate shows a noticeable reduction in the sudden loss of volatiles around 100° C. and 200° C. but a more gradual weight loss with increasing temperature.

FIGS. 15 and 16 show two silicon carbide/graphite crucibles based on sugar based mixes comprising ˜13% Adeptose B51™ and 2% dextrine as binders. These crucibles were “cured” at a rate of 15° C./hour to 150° C. from a starting temperature of 90° C. The crucible in FIG. 15 contains no polyacrylate and the one in FIG. 16 contains 0.38% polyacrylate. It is clear that the presence of a minute amount of polyacrylate has eliminated the problem of blistering and bloating at such short drying cycles.

In addition to retaining water above the boiling point, when superabsorbers absorb water they swell greatly. As the water is lost the superabsorber will shrink so creating porosity around the superabsorber that will assist in escape of vapour.

The applicants have also determined that other sugars are effective as a replacement for the Adeptose B51™ and have used with success mylose from Amiylum Group of Greenwich, London, a division of Tate & Lyle.

Cross-Linking Agents and Catalysis of Carbonisation

The results given above indicate that varying the curing conditions can result in variation of the fired carbon yield iron a sugar-based binder. The binder may advantageously be catalysed, and the present invention encompasses the use of cross-linked sugar binders.

The above description has shown the effectiveness of superabsorbers as drying aids for ceramics in the context of a sugar-based binder system. The invention can be used more widely as drying is a problem for many ceramic systems. The present invention is not limited to sugar-based binder systems, and is not limited to the production of crucibles. The invention may be useful for all ceramic systems where drying is a process step.

Examples of ceramic articles that can benefit from the use of hygroscopic polymeric materials in manufacture include:—bricks; tiles; shaped insulating refractories; refractory cements; molten metal contacting refractories, for example crucibles, launders, and moulds; furnace parts; and burner parts.

1. A method of forming a ceramic material or body comprising the steps of:—
i) providing a water-containing mixture of raw materials
ii) forming said mixture into a shape
iii) removing water from said shape
iv) firing said shape at a temperature sufficient to effect sintering and/or reaction of the raw materials and thereby form a ceramic material or body
in which the raw materials include a hygroscopic polymeric material capable of retaining water in the mixture over a range of temperatures above the boiling point of water.

2. A method as claimed in claim 1, in which the hygroscopic polymeric material is present in the mixture in amounts less than 5% by weight of the dry ingredients.

3. A method as claimed in claim 2, in which the hygroscopic polymeric material is present in the mixture in amounts less than 1% by weight of the dry ingredients.

4. A method as claimed in claim 1, in which the hygroscopic polymeric material has an absorbency of more than 5 grams of water per gram of material.

5. A method as claimed in claim 4, in which the hygroscopic polymeric material has an absorbency of more than 10 grams of water per gram of material.

6. A method as claimed in claim 5, in which the hygroscopic polymeric material has an absorbency of more than 100 grams of water per gram of material.

7. A method as claimed in claim 6, in which the hygroscopic polymeric material has an absorbency of more than 200 grams of water per gram of material.

8. A method as claimed in claim 1, in which the hygroscopic polymeric material is a polyacrylate.

9. A method as claimed in claim 1, in which the hygroscopic polymeric material comprises a fine powder with 75% by weight or more of a size less than 150 μm.

10. A method as claimed in claim 1, in which the raw materials include a carbonisable binder.

11. A method as claimed in claim 10, in which the carbonisable binder is a sugar-based binder.

12. A method as claimed in claim 11, in which the sugar-based binder comprises a mixture of a syrup and a starch.

13. A method as claimed in claim 1, in which the raw materials include silicon carbide and graphite.

14. A method as claimed in claim 13, in which the ceramic body is a crucible.

15. Use as a component of a raw material mixture used in the production of a ceramic, of a hygroscopic polymeric material to retain water in the mixture over a range of temperatures above the boiling point of water.

16. A raw material mixture, used in the production of a ceramic, including a hygroscopic polymeric material capable of retaining water in the mixture at a range of temperatures above the boiling point of water.

17. A raw material mixture as claimed in claim 16, in which the hygroscopic polymeric material is present in the mixture in amounts less than 5% by weight of the dry ingredients.

18. A raw material mixture as claimed in claim 17, in which the hygroscopic polymeric material is present in the mixture in amounts less than 1% by weight of the dry ingredients.

19. A raw material mixture as claimed in claim 16, in which the hygroscopic polymeric material has an absorbency of more than 5 grams of water per gram of material.

20. A raw material mixture as claimed in claim 19, in which the hygroscopic polymeric material has an absorbency of more than 10 grams of water per gram of material.

21. A raw material mixture as claimed in claim 20, in which the hygroscopic polymeric material has an absorbency of more than 100 grams of water per gram of material.

22. A raw material mixture as claimed in claim 21, in which the hygroscopic polymeric material has an absorbency of more than 200 grams of water per gram of material.

23. A raw material mixture as claimed in claim 16, in which the hygroscopic polymeric material is a polyacrylate.

24. A raw material mixture as claimed in claim 16, in which the hygroscopic polymeric material comprises a fine powder with 75% by weight or more of a size less than 150 μm.

25. A raw material mixture as claimed in claim 16, including a carbonisable binder.

26. A raw material mixture as claimed in claim 25, in which the carbonisable binder is a sugar-based binder.

27. A raw material mixture as claimed in claim 26, in which the sugar-based binder comprises a mixture of a syrup and a starch.

28. A raw material mixture as claimed in claim 16, including silicon carbide and graphite.

29. A binder for a ceramic, comprising one or more reactive components to provide a fired bond in the ceramic, and a hygroscopic polymeric material.

30. A binder, as claimed in claim 29, in which the hygroscopic polymeric material has an absorbency of more than 5 grams of water per gram of material.

31. A binder, as claimed in claim 30, in which the hygroscopic polymeric material has an absorbency of more than 10 grams of water per gram of material.

32. A binder, as claimed in claim 31, in which the hygroscopic polymeric material has an absorbency of more than 100 grams of water per gram of material.

33. A binder, as claimed in claim 32, in which the hygroscopic polymeric material has an absorbency of more than 200 grams of water per gram of material.

34. A binder, as claimed in claim 29, in which the hygroscopic polymeric material comprises a polyacrylate.

35. A binder, as claimed in claim 29, in which the reactive components include a carbonisable material.

36. A binder, as claimed in claim 35, in which the carbonisable binder is a sugar-based binder.

37. A binder, as claimed in claim 36, in which the sugar-based binder comprises a mixture of a sugar syrup and a starch.

38. A binder, as claimed in claim 37, in which the sugar syrup has a solids content of greater than 70%.

39. A binder, as claimed in claim 38, in which the sugar syrup has a carbon content as assessed by TGA of above 10% by weight.

40. A binder, as claimed in claim 39, in which the sugar syrup has a carbon content as assessed by TGA of above 15% by weight.

41. A binder, as claimed in claim 35, providing a carbon yield when carbonised of greater than 20%.

42. A method of forming a ceramic article by the steps of forming a green body and firing the green body at a temperature sufficient to carbonise a carbonisable binder in the green body, in which the carbonisable binder comprises a sugar syrup and a carbonaceous additive increasing the carbon yield of the binder upon firing.

43. A method as claimed in claim 42, in which the carbonaceous additive is a starch.

44. A method as claimed in claim 42, in which the carbonisable binder has a carbon yield of greater than 20%.

45. A method as claimed in claim 42, in which the sugar syrup has a solids content of greater than 70%.

46. A method as claimed in claim 42, in which the ash content of the sugar syrup is less than 5%.

47. A method as claimed in claim 46, in which the ash content of the sugar syrup is less than 1%.
